(19) United States
(12) Patent Application Publication
(10) Pub. No.: US 2021/0131576 A1
(43) Pub. Date: May 6, 2021

(54) GAS SEDIMENT TRAP ASSEMBLY

(71) Applicant: NIBCO Inc., Elkhart, IN (US)

(72) Inventors: Mark Roy, JR., Boylston, MA (US); Andrew J. Terry, Sturbridge, MA (US); Christopher W. Mason, Granger, IN (US)

(73) Assignee: NIBCO Inc., Elkhart, IN (US)

(21) Appl. No.: 17/143,430

(22) Filed: Jan. 7, 2021

Related U.S. Application Data
(62) Division of application No. 15/828,755, filed on Dec. 1, 2017.

(51) Int. Cl. F16K 11/10; F16K 5/08; F16K 11/20; F16K 1/14; F16K 5/06

(52) U.S. Cl. CPC F16K 11/105; F16K 5/08; F24B 1/189; F16K 1/14; F16K 5/06; F16K 11/20

(57) ABSTRACT

A gas sediment trap assembly includes a generally cylindrical length with a generally perpendicular tee and a vertically oriented capped portion. The gas sediment trap assembly is coupled to the gas supply line and the gas fired appliance. One or more gas ball valves can be coupled to the gas sediment trap assembly. The gas sediment trap assembly can be used with conventional gas piping, flexible gas piping, and/or other gas line components.

### CROSS REFERENCE TO RELATED APPLICATION AND CLAIM TO PRIORITY

The present application is a divisional application of commonly assigned, pending U.S. patent application Ser. No. 15/828,755 filed Dec. 1, 2017, which is incorporated herein by reference and claim priority thereto under 35 U.S.C. § 120.

### BACKGROUND OF THE INVENTION

The present invention relates to gas sediment traps. Gas fired appliances, such as furnaces, heaters, boilers, etc. require a gas line from the incoming gas supply to fuel the appliance. Connected to the gas lines is an extra leg of piping referred to as a sediment trap. Sediment traps are intentionally installed to prevent sediment, dirt or particulates in the gas or piping, from getting into the burner area of the appliance or associated components such as the gas ball valve connected upstream of the appliance. Specifically, a gas sediment trap uses gravity to capture sediment before it travels to the gas fired appliance. Sediment traps are usually required at all gas appliances as part of the International Fuel Gas Code. The International Fuel Gas Code for the Sediment Trap section 408.4 (2015) states that when a sediment trap is not incorporated as part of the appliance, a sediment trap shall be installed downstream of the appliance shutoff valve as close to the inlet of the appliance as practical. Sediment traps are generally required by code on all furnaces, boilers, and water heaters, in all states in the United States.

FIG. 1 illustrates an example of a piping arrangement shown in a typical installation manual for a gas fired boiler 200. The gas fired boiler 200 includes a manual shutoff valve 202, which is connected to a ground joint union 204, which is connected to a tee 206. The tee 206 on the upper end includes a service valve 208 and on the bottom end includes a cap 210.

Currently there are several methods used to connect the gas line to the appliance. FIG. 2 illustrates the most common sediment trap arrangement. In that example, the gas fired appliance 138 is connected to the gas supply line 120. That connection is accomplished by a ball valve 112, which is connected to a pipe nipple 124 connected to a tee 122. On the bottom of the tee 122, is another pipe nipple 124 in a generally vertical orientation, which is capped with cap 135. The pipe nipple 124 and cap 135 act as the gas sediment trap. The generally horizontal portion of the tee 122 is connected to another pipe nipple 124, which is connected to another pipe nipple 124 by a union 130. A 90° elbow 132 is connected to another pipe nipple 124, which is connected to another ball valve 112. That ball valve 112 is connected to a gas inlet 134 of the gas fired appliance 138.

FIG. 3 illustrates another prior art example of a typical piping arrangement when the installer uses a flexible hose to connect the gas supply 120 to the gas fired appliance 138. In that example, the supply pipe 120 is connected to the ball valve 112, which is connected to a pipe nipple 124. That pipe nipple 124 is connected to a tee 122. At the bottom of the tee 122, in a generally vertical direction, is another pipe nipple 124 with a pipe cap 135. The generally horizontal portion of the tee 122 is connected to another pipe nipple 124, which is connected to a gas hose 142. That gas hose 142 is connected to a ball valve 112, which is connected to the gas inlet 134 to the gas fired appliance 138. The above described components, including the iron pipe components, hoses, fittings, ball valves, etc. are all gas certified components.

### SUMMARY OF THE INVENTION

One aspect of the present invention is a gas sediment trap assembly. The gas sediment trap assembly includes a body having a generally cylindrical length with a first end portion configured to be coupled to a gas ball valve connected to the gas supply line. The body also has a second end portion coupled to a cap. The medial portion of the body is located between the first end portion and the second end portion. The medial end portion includes a tee with a portion extending generally perpendicular to the length of the body.

Another aspect of the present invention is a gas sediment trap assembly having a body with a generally cylindrical length. The body includes a first end portion with a gas ball valve to be coupled to the inlet of a gas fired appliance. The body also includes a second end portion and a medial portion located between the first end portion and the second end portion. The medial portion includes a tee with a portion extending generally perpendicular to the length of the body. A cap is coupled to the second end portion of the body.

Another aspect of the present invention is a method for connecting a gas sediment trap assembly to a gas fired appliance. The method includes selecting a gas sediment trap assembly with a body having a generally cylindrical length. The body includes a first end portion, a second end portion, and a medial portion located between the first end portion and second end portion. The medial portion includes a tee with a portion extending generally perpendicular to the length of the body. The method includes coupling the first end portion of the gas sediment trap assembly to a gas ball valve. The method includes coupling the generally perpendicular portion of the tee to a gas line that is coupled to another gas ball valve. The method also includes coupling a cap on the second end portion of the body of the gas sediment trap assembly.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partial perspective view of a prior art piping arrangement with a gas sediment trap for a gas fired appliance;

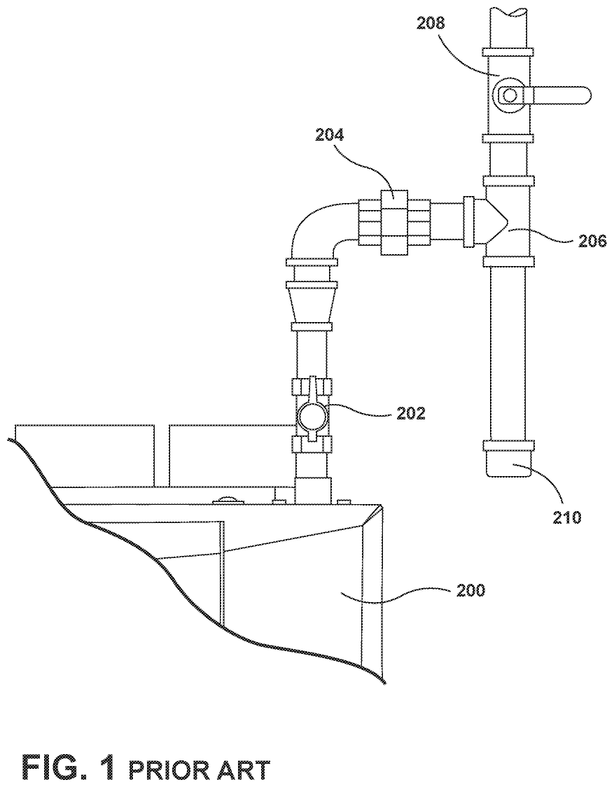

FIG. 2 is a partial perspective view of another prior art gas sediment trap assembly using iron piping fittings;

FIG. 3 is a partial perspective view of another prior art gas sediment trap assembly utilizing a gas hose to connect the gas line to the gas fired appliance;

FIG. 4 is a partial perspective view of an embodiment of the gas sediment trap assembly;

FIG. 5 is a partial perspective view of another embodiment of the gas sediment trap assembly;

FIG. 6 is a partial perspective view of another embodiment of the gas sediment trap assembly; and

FIG. 7 is a partial perspective view of another embodiment of the gas sediment trap assembly utilizing a flexible gas hose.

### DETAILED DESCRIPTION

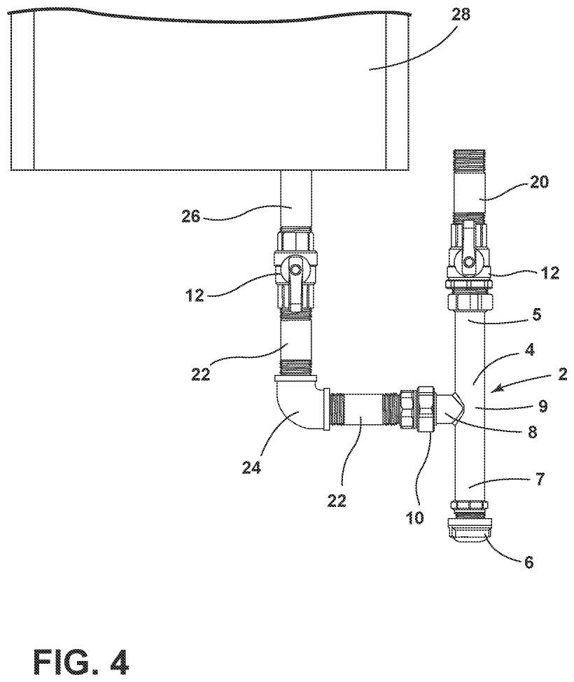

For purposes of description herein, the terms “upper,” “lower,” “right,” “left,” “rear,” “front,” “vertical,” “horizontal,” and derivatives thereof shall relate to the invention as oriented in FIGS. 4-7. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 4 illustrates one embodiment of the gas sediment trap assembly 2. The gas sediment trap assembly 2 includes a body 4 with a generally cylindrical length with a tee portion 8. The body 4 includes a first end portion 5, a second end portion 7, and a medial portion 9. The distance between the tee portion 8 and the cap 6 is at least 3″. The second end portion 7 is capped with a cap 6 to create the gas sediment trap portion of the gas sediment trap assembly 2. The gas sediment trap assembly 2 is directly connected to a gas ball valve 12 that is connected to a gas supply line 20. The gas sediment trap assembly 2 in FIG. 4 includes an FIP union that is connected to a pipe nipple 22, which is connected to a 90° elbow 24 and another pipe nipple 22. A gas ball valve 12 is connected to that pipe nipple 22. That gas ball valve 12 is ultimately connected to a gas inlet 26 of the gas fired appliance 28.

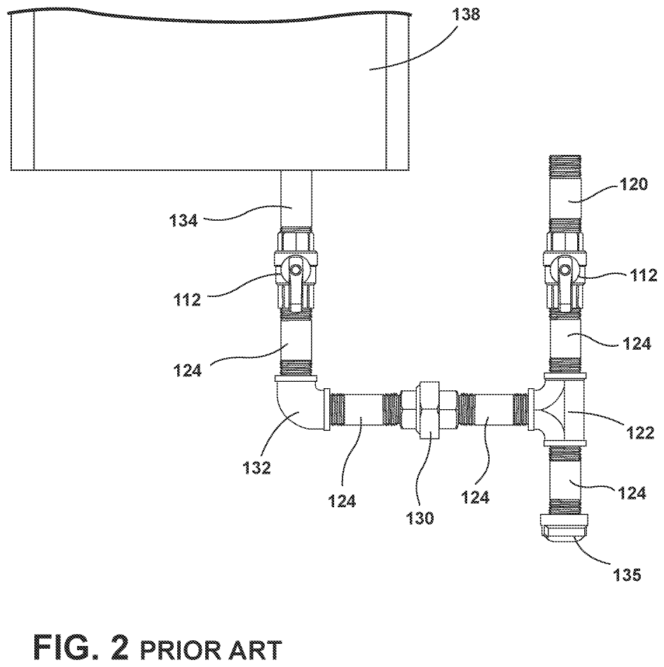

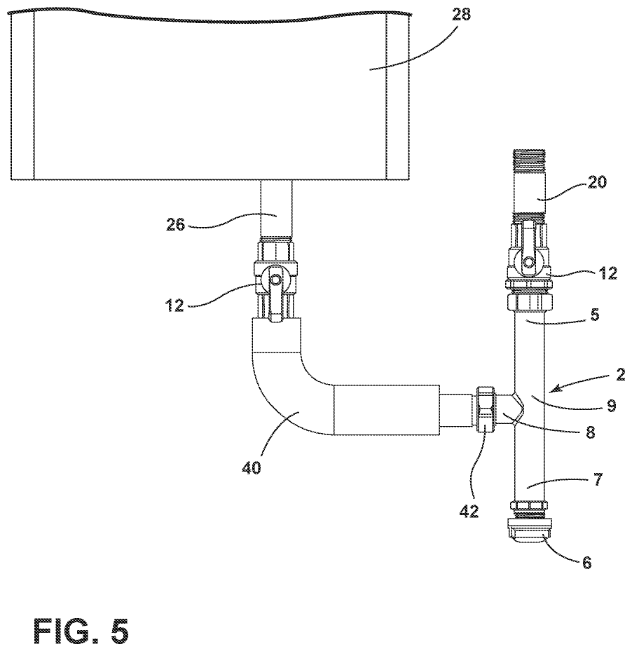

FIG. 5 illustrates the gas sediment trap assembly 2 with a male flare union 42, which is connected to a gas hose 40 with a flare x flare connection. The gas hose 40 is connected to a gas ball valve 12, which is ultimately connected to the gas inlet 26 of the gas fired appliance 28. The gas sediment trap assemblies 2 illustrated in FIGS. 4 and 5 eliminate potential gas leak paths when compared to the prior art while also saving the contractor or homeowner valuable installation time. For example, the gas sediment trap assembly 2 illustrated in FIG. 4 eliminates at least three potential leak paths when compared to the prior art example shown in FIG. 2.

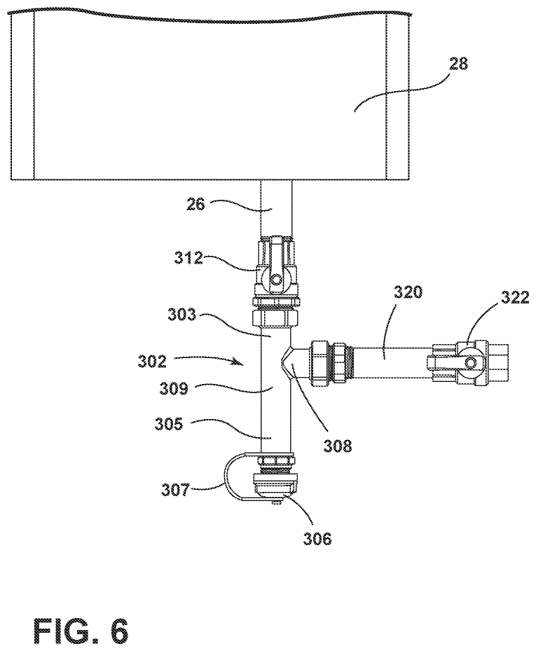

Another embodiment of the present invention is illustrated in FIG. 6. In that embodiment, a gas ball valve 312 is an integral part of a gas sediment trap assembly 302. The gas sediment trap assembly 302 includes a first end portion 303 and a second end portion 305 to which a pipe cap with a strap 306 is attached. The gas sediment trap assembly 302 includes a medial portion 309 with a tee 308 which attaches to an iron pipe 320 and to a ball valve 322, which is connected to the gas supply line (not shown). The first end portion 303 of the gas sediment trap assembly 302 includes the integrated gas ball valve 312, which connects to the gas inlet 26 of the gas fired appliance 28.

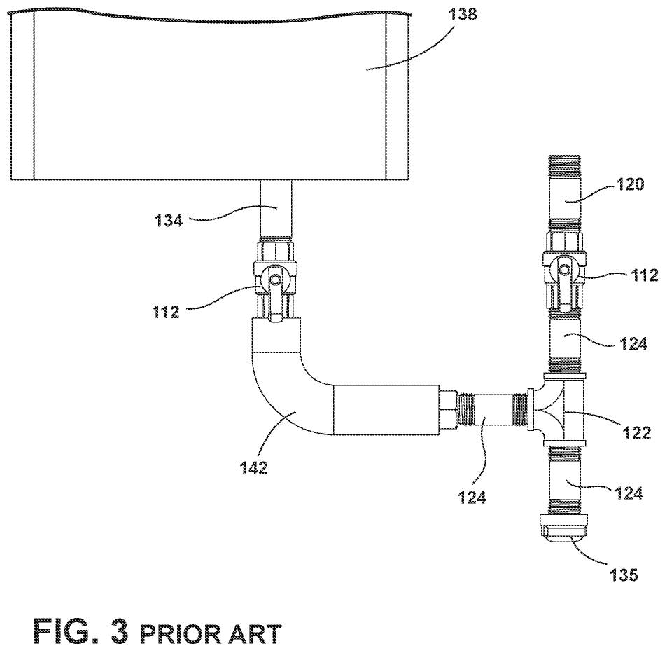

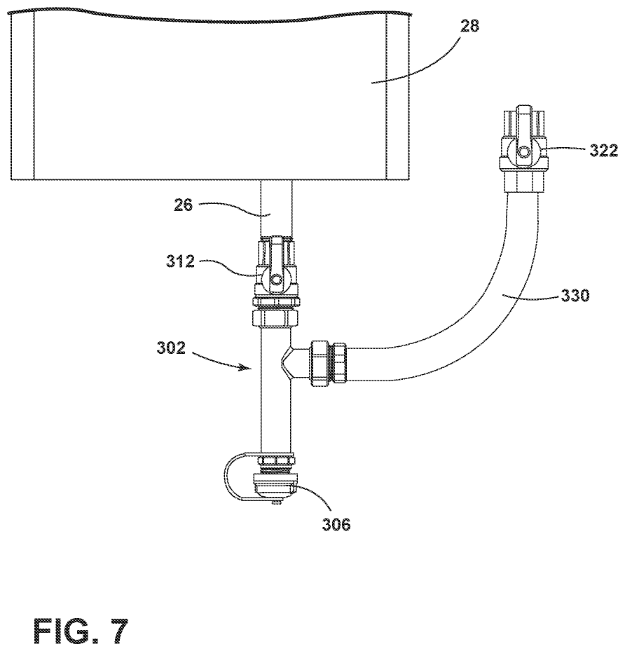

FIG. 7 illustrates the gas sediment trap assembly 302 connected to a certified flexible gas hose 330, which is connected to a gas ball valve 322. The gas ball valve 322 is connected to the gas supply line (not shown). The gas sediment trap assembly 302 illustrated in FIGS. 6 and 7 eliminates even more potential leak paths when compared to the prior art shown in FIGS. 2 and 3. Again, this makes the gas sediment trap assembly 302 safer while saving the contractor or homeowner even more valuable installation time.

The gas sediment trap assemblies 2, 302 can be made out of any material that is typically used with and/or certified for use with gas piping. This includes, for example, brass, forged brass, iron, steel, and other suitable materials. The gas sediment trap assemblies 2, 302 can be made of the same materials as ball valves 12, 312.

In the illustrated embodiments, the piping and piping connections are generally designed for ¾″ piping. However, the components could be adapted to different sized piping and/or include portions that are adapted to taper up or down to different sized piping. The components, such as ball valves, hoses, fittings, pipe, etc., are certified for use with gas. Any type of connection can be used to couple the ends of gas sediment trap assemblies 2, 302, to the gas supply line and to the gas fired appliance 28. While different embodiments have shown threaded, compression, flare, National Pipe Thread (NPT), Male Iron Pipe (MIP), Female Iron Pipe (FIP), or other types of gas approved conventional connections, it is to be understood that any type of conventional connection that couples two or more components without creating a leak can be utilized.

In the foregoing description, it will be readily appreciated by those skilled in the art that modifications may be made to the invention without departing from the concepts disclosed herein. Such modifications are to be considered as included in the following claims, unless these claims by their language expressly state otherwise.

It will be understood by one having ordinary skill in the art that construction of the present disclosure and other components is not limited to any specific material. Other exemplary embodiments of the disclosure disclosed herein may be formed from a wide variety of materials, unless described otherwise herein.

For purposes of this disclosure, the term “coupled” or “operably coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the term “connected” or “operably connected” (in all of its forms, connect, connecting, connected, etc.) generally means that one component functions with respect to another component, even if there are other components located between the first and second component, and the term “operable” defines a functional relationship between components.

It is also important to note that the construction and arrangement of the elements of the present disclosure as shown in the exemplary embodiments is illustrative only. Although only a few embodiments of the present innovations have been described in detail in this disclosure, those skilled in the art who review this disclosure will readily appreciate that, unless otherwise described, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating positions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

The invention claimed is:

1. A gas sediment trap assembly comprising:
a single piece body having a generally cylindrical length, comprising:
a first end portion with a gas ball valve housing;
a second end portion;
a medial portion located between said first end portion and said second end portion, said medial portion including a tee with a portion extending generally perpendicular to said length of said body;
a gas certified ball and a stem positioned within said gas ball valve housing of said first end portion; and
a cap directly coupled to said second end portion of said body thereby forming a closed generally vertical sediment trap in said second end portion.

2. A gas sediment trap assembly as set forth in claim 1, wherein said generally perpendicular portion of said tee includes an FIP union for coupling to a pipe nipple.

3. A gas sediment trap assembly as set forth in claim 1, wherein said generally perpendicular portion of said tee includes a male flare union for coupling to a gas hose with a flare connection.

4. A gas sediment trap assembly as set forth in claim 1, including a handle coupled to said stem.

5. A gas sediment trap assembly as set forth in claim 1, wherein said cap is removable.

6. A gas sediment trap assembly as set forth in claim 5, wherein said gas ball valve housing couples to a gas supply line.

7. A gas sediment trap assembly as set forth in claim 1, wherein said gas ball valve housing couples to an appliance.

8. A gas sediment trap assembly comprising:
a single piece body having a generally cylindrical length, comprising:
a first end portion with a gas ball valve housing;
a second end portion;
a medial portion located between said first end portion and said second end portion, said medial portion including a tee with a portion extending generally perpendicular to said length of said body;
a gas certified ball and a stem positioned in said gas ball valve housing; and
a cap coupled to said second end portion of said body to create a generally vertical sediment trap.

9. A gas sediment trap assembly as set forth in claim 8, wherein said cap is coupled to a strap that is coupled to said second end portion of said body.

10. A gas sediment trap assembly as set forth in claim 8, wherein said generally perpendicular portion of said tee includes an FIP union for coupling to a pipe nipple.

11. A gas sediment trap assembly as set forth in claim 8, wherein said generally perpendicular portion of said tee is coupled to a certified flexible gas hose.

12. A gas sediment trap assembly as set forth in claim 11, wherein said certified flexible gas hose is coupled to a certified gas ball valve.

13. A gas sediment trap assembly as set forth in claim 8, wherein said gas ball valve housing is coupled to a gas fired appliance.

14. A method for connecting a gas sediment trap assembly to a gas fired appliance, comprising:
selecting a gas sediment trap assembly with a body having a generally cylindrical length, comprising:
a first end portion with an integral gas ball valve;
a second end portion;
a medial portion located between said first end portion and said second end portion, said medial portion including a tee with a portion extending generally perpendicular to said length of said body; and
coupling said first end portion of the gas sediment trap assembly directly to an appliance;
coupling said generally perpendicular portion of said tee to a gas line that is coupled to a second gas ball valve; and
coupling a cap directly on said second end portion of said body to provide a generally vertical trap for sediment.

15. A method as set forth in claim 14, wherein:
said tee coupling step includes said perpendicular portion of said tee to a gas pipe nipple that is coupled to a 90° elbow.

16. A method as set forth in claim 14, wherein:
said tee coupling step includes coupling said perpendicular portion of said tee to an iron pipe.

17. A method as set forth in claim 14, wherein:
said tee coupling step includes coupling said perpendicular portion of said tee to a flexible gas hose.

18. A method as set forth in claim 14, wherein:
said integral gas ball valve is coupled to a gas supply line.

19. A method as set forth in claim 14, wherein:
said integral gas ball valve is coupled to the inlet of the gas fired appliance.

20. A method as set forth in claim 14, wherein:
said integral and second ball valves include the same type of handle.
